(19) United States
(12) Patent Application Publication
(10) Pub. No.: US 2014/0291401 A1
(43) Pub. Date: Oct. 2, 2014

(54) SYMBOL INFORMATION READER, SYMBOL INFORMATION READING METHOD AND PROGRAM TO EXECUTE IT

(71) Applicant: NIDEC SANKYO CORPORATION, NAGANO (JP)

(72) Inventor: Hiroshi NAKAMURA, Nagano (JP)

(73) Assignee: NIDEC SANKYO CORPORATION, NAGANO (JP)

(21) Appl. No.: 14/226,137

(22) Filed: Mar. 26, 2014

(30) Foreign Application Priority Data
Mar. 29, 2013 (JP) 2013-073827

(51) Int. Cl. G06K 7/14

(52) U.S. Cl. CPC G06K 7/1443
USPC 235/462.08

(57) ABSTRACT

A symbol information reader may include an imaging device configured to image the medium; an image memory configured to store image data of the medium; and a position detection processor configured to retrieve the image data and detect the position of symbol information recorded on the medium. The position detection processor may include a temporary area judging unit; a correlation map creating unit; a labeling unit configured, and a position determining unit configured to detect the position of the symbol information recorded on the medium. When searching the correlation map for a predetermined basic pattern and labeling, the labeling unit judges whether the basic pattern is present or not according to the ratio of high correlation area to the area subject to judgment or the position of high correlation area in the basic pattern.

### CROSS REFERENCE TO RELATED APPLICATION

The present invention claims priority under 35 U.S.C. §119 to Japanese Application No. 2013-073827 filed Mar. 29, 2013, the entire contents of which are incorporated herein by reference.

### FIELD OF THE INVENTION

The present invention relates to a symbol information reader which optically reads symbol information such as barcode symbols, a method for reading symbol information and a program to execute it.

### BACKGROUND

Conventionally barcode symbols have widely used as means which provide media such as papers, plastics, etc. with unique information and recognize the information automatically.

In merchandise control and distribution management, information in the barcode symbol attached to the merchandise is read by a barcode reader such as a laser scanner or a CCD camera.

In recent years, a new type of barcode reader has debuted as a symbol information reader which scans the entire surface of an ID card to capture its image and to recognize a barcode based on the image, in which a personal identification number has been recorded.

For this type of barcode reader, it is important that the barcode symbol is accurately detected from a two dimensional image space.

Patent Reference 1 has proposed a symbol information reader capable of reducing computational complexity that is necessary to read the symbol information such as barcode symbols.

This symbol information reader comprises an imaging element, an image memory for storing the image data of a medium acquired by the imaging element, and a position detection processor for retrieving the image data and detecting the position of the symbol information recorded (printed) on the medium.

The position detection processor is equipped with a temporary area judging unit which calculates brightness changes along the scanning direction of scanning lines for the symbol information in a predetermined area of the image data to determine a temporary area that has a possibility of corresponding to the symbol information, a correlation map creating unit which acquires correlations of the temporary area with areas neighboring in the direction perpendicular to the scanning direction of the scanning lines and creates a map that indicates areas of high correlation value, a labeling unit which searches the correlation map for the presence of a basic barcode and labels the area judged as having the basic barcode, and a position determining unit which detects the position of the symbol information recorded (printed) on the medium, based on the labeled area.

### [Patent Reference] Unexamined Japanese Patent Application 2009-266190 Publication

In the labeling process at the labeling unit of the above-described symbol information reader, as disclosed in the paragraph [0050] of Patent reference 1, the reader searches the correlation map which shows the presence of a barcode symbol for the presence of the basic barcode symbol pattern ([222] in the embodiment) while shifting on the map by one element by element; when the pattern is detected, a label of a value ‘1’ is put on each of the corresponding elements on the barcode map.

Normally, a label of a value ‘1’ is put on the areas in which a barcode symbol is present and a label of a value ‘0’ is put on other areas; the arrangement pattern of ‘1’ and ‘0’ is analyzed in the position-determining processing unit in the next step to determine the left edge and right edge positions of the barcode symbol area.

If a certain portion of the correlation map appears [1 2 2 2 2 2 2 2 2 2 1], the arrangement pattern of ‘1’ and ‘0’ is normally labeled as [0 1 1 1 1 1 1 1 1 1 0] in its barcode map; by looking for ‘0’ appearing at both sides of the consecutive ‘1”, the left and right end positions of the barcode symbol can be determined.

However, the same barcode symbol may appear as [1 2 2 2 2 2 1 2 2 2 1] in the correlation map sometimes and labeled as [0 1 1 1 1 1 0 1 1 1 0] in its barcode map.

In this case, the ‘0’ in the middle is mistakenly judged as the end point, and consequently the barcode symbol is detected shorter than the actual barcode.

### SUMMARY

Then, at least an embodiment of the present invention provides a symbol information reader capable of accurately reading the entire symbol information while preventing mis-judgments on reading of symbol information such as barcode symbols, a method for reading symbol information and a program to execute the method.

At least an embodiment of the present invention comprises a symbol information reader comprising an imaging means for imaging an medium on which the symbol information is recorded (printed), an image memory for storing the image data of the medium captured by the imaging means, and a position detection processor for retrieving the image data and detecting the position of the symbol information recorded (printed) on the medium; wherein the position detecting processor includes a temporary area judging unit for calculating brightness changes along the scanning direction of scanning lines for the symbol information in a predetermined area of the image data and identifying a temporary area having a possibility of corresponding to the symbol information, a correlation map creating unit for acquiring correlations of the temporary area with the areas neighboring in the direction perpendicular to the scanning direction of the scanning lines and creating a map that indicates the areas of high correlation value, a labeling unit for searching the correlation map for the presence of the basic barcode and labeling the area judged as having the basic barcode, and a position determining unit for detecting the position of the symbol information recorded (printed) on the medium, based on the labeled area; when searching for the presence of a predetermined basic pattern in the correlation map acquired at the correlation map creating unit and labeling, the labeling unit judges whether the basic pattern is present or not according to the ratio of the high correlation area to the area subject to judgment or the position of the high correlation area in the basic pattern.

At least an embodiment of the present invention is a method for reading symbol information comprising an imaging step for imaging a medium on which the symbol information is recorded, an image storing step for storing the image data of the medium captured by the imaging means, and a position detection processing step for retrieving the image data and detecting the position of the symbol information recorded on the medium; the position detection processing step includes a temporary area judging step in which brightness changes are calculated along the scanning direction of scanning lines of the symbol information in a predetermined area of the image data and a temporary area having a possibility of corresponding to the symbol information is identified, a correlation map creating step in which correlations of the temporary area are calculated with respect to the areas neighboring in the direction perpendicular to the scanning direction of the scanning lines and a map is created to indicate the areas of high correlation value, a labeling step in which the presence of the basic barcode is searched for in the correlation map and the area judged as having the basic barcode is labeled, and a position determining step in which the position of the symbol information recorded on the medium is detected, based on the labeled area; in the labeling step, when the presence of a predetermined basic pattern in the correlation map acquired at the correlation map creating unit is searched and labeled, it is judged whether the basic pattern is present or not, according to the ratio of the high correlation area to the area subject to judgment or the position of the high correlation area in the basic pattern.

At least an embodiment of the present invention is a computer program that executes a symbol information reading operation including a position detection operation for retrieving the image data of the medium captured by imaging a medium on which symbol information is recorded with an imaging device and detecting the position of the symbol information recorded on the medium; the position detecting operation includes a temporary area judging operation for calculating brightness changes along the scanning direction of scanning lines of the symbol information in a predetermined area of the image data and identifying a temporary area having a possibility of corresponding to the symbol information, a correlation map creating operation for acquiring correlations of the temporary area with the areas neighboring in the direction perpendicular to the scanning direction of the scanning lines and creating a map that indicates the areas of high correlation value, a labeling operation for searching for the presence of the basic barcode in the correlation map and labeling the area judged as having the basic barcode, and a position determining operation for detecting the position of the symbol information recorded on the medium, based on the labeled area; in the labeling process, when the presence of a predetermined basic pattern in the correlation map acquired at the correlation map creating section is searched and labeled, it is judged whether the basic pattern is present or not, according to the ratio of the high correlation area to the entire area subject to judgment or the position of the high correlation area in the basic pattern.

According to at least an embodiment the present invention, a misjudgment on reading of symbol information such as barcode symbols can be prevented, enabling an accurate reading of the entire symbol information.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 A diagram to show an example of the configuration of a symbol information reader of an embodiment of the present invention.

FIG. 2 A flowchart showing the workflow of the symbol information reading operation of the embodiment of the present invention.

FIG. 3 A flowchart showing the workflow of the information processing of the symbol detection of FIG. 2.

FIG. 4 A diagram showing an example of the image data of a medium stored in an image memory.

FIG. 5 An image expressing map values.

FIG. 6 Binarized data of the map shown in FIG. 5.

FIG. 7 A correlation map resulted from correlation calculations of objective lines with respect to the lines above and below.

FIG. 8 A barcode map resulted from the correlation map shown in FIG. 7.

FIG. 9 A profile of average brightness in the vicinity of the barcode symbol.

FIG. 10 An example in which a white seam line overlaps the position of one of the lines (the line above or below the objective line).

FIG. 11 An example of a correlation map created when the white seam line of FIG. 10 overlaps one of the lines (below or above the objective line).

FIG. 12 The result after a basic pattern search operation is applied on the correlation map of FIG. 11.

FIG. 13 An example of a correlation map created in a matrix of 13 rows×30 columns.

FIG. 14 A barcode map resulted from the labeling when a precise agreement with a pre-set mask pattern is sought in the basic pattern search operation, as seen in an existing symbol information reader.

FIG. 15 A barcode map resulted from the labeling when, in a basic pattern search operation of the symbol information reader of this embodiment, it is determined that a basic pattern is present when the sum of element values of all the elements in the basic pattern is equal to or larger than a predetermined value.

FIG. 16 An image of a medium on which a 2D barcode is printed.

FIG. 17 A correlation map resulted from applying the processing steps of position detection to the image shown in FIG. 16.

FIG. 18 An example of a medium on which multiple kinds of barcode symbols are printed.

FIG. 19 A correlation map acquired according to FIG. 18.

### DETAILED DESCRIPTION

At least an embodiment of the invention is described hereinafter referring to the drawings.

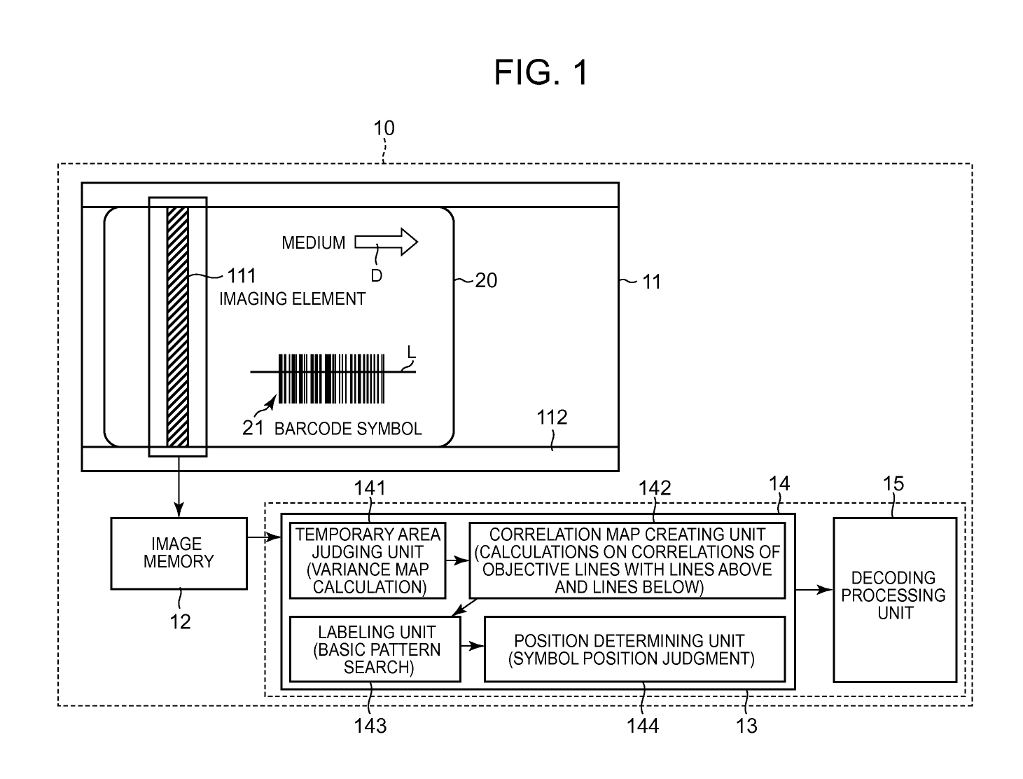

FIG. 1 shows an example of the configuration of a symbol information reader of an embodiment of the present invention.

A symbol information reader 10 of this embodiment is configured to process image data captured by imaging symbol information provided as specific information on a medium such as paper or plastic (in this embodiment, a 1D barcode symbol or a 2D barcode symbol) in order to accurately read the entire symbol information from the image data.

As shown in FIG. 1, the symbol information reader 10 has an imaging device 11, an image memory 12 as a storage unit, and a data processor 13 as primary components.

The imaging device 11 includes a contact-type 1D imaging element 111 and a card transfer mechanism (including a transfer guide) for transferring a medium 20 such as a card.

As FIG. 1 shows, a barcode symbol 21 of a 1D barcode is printed as an example of symbol information on the medium 20 such as a card which is imaged by the imaging element 111 of the imaging device 11.

Note that in FIG. 1, code D shows the transferring direction of the medium 20 while code L shows a scanning line for the barcode symbol 21 of the 1D barcode.

In this embodiment, a contact-type 1D imaging element is adopted for the imaging element 111 to minimize the device; however, the imaging element 111 may adopt a 2D area sensor that reads a character line on the medium 20 to be read.

The imaging element 111 is configured by a CCD or a CMOS.

The image memory 12 stores the image data of the medium 20 containing the barcode symbol of a 1D barcode captured by the imaging element 111.

Note that the image memory 12 may be any memory such as a RAM, a SDRAM, a DDRSDRAM or a RDRAM as long as image data can be stored.

The data processor 13 has a position detection processing unit 14 and a decoding processing unit 15 as primary components.

The position detection processing unit 14 of this embodiment has a temporary area judging unit 141, a correlation map creating unit 142, a labeling unit 143 and a position determining unit 144.

Note that each component configuring the position detection processing unit 14 can be materialized with hardware such as a CPU, a ROM and a RAM.

Although, in this embodiment, the position detection processing unit 14 and the decoding processing unit 15 are illustrated as separate components, the decoding processing unit 15 may be installed in the position detection processing unit 14.

The temporary area judging unit 141 calculates brightness changes along the scanning direction of the one-dimensional scanning lines L for the symbol information in a predetermined area in the image data retrieved from the image memory 12 (in this embodiment, the barcode symbol 21 of a 1D barcode) and judges (identifies) a temporary area having a possibility of corresponding to the symbol information.

The temporary area judging unit 141 uses variance or standard deviation to calculate brightness changes. The temporary area judging unit 141 of this embodiment calculates a variance map, for example, and judges whether it is a temporary area or not according to the result [of the variance map]. In other words, the temporary area judging unit 141 of this embodiment is configured to include a function of variance map calculation.

The correlation map creating unit 142 acquires correlations of the temporary area identified by the temporary area judging unit 141 with the neighboring areas adjacent in the direction perpendicular to the scanning direction of the scanning lines L and creates a correlation map that shows the areas of high correlation value.

The correlation map creating unit 142 of this embodiment implements a so-called correlation calculations with respect to the lines above and below [objective lines] in order to discriminate a barcode symbol, which is symbol information, from the rest.

In other words, the correlation map creating unit 142 calculates, with respect to each element with a value ‘1’ on the lattice map, correlations of the brightness on the lines between the objective block (line) and the neighboring blocks (lines) adjacent right above and right below. If those blocks contain a barcode symbol, their correlation values should be large.

More specifically described, the correlation map creating unit 142 creates a line correlation map on the lattice coordinates.

As described later, if the correlation values between the objective line and the lines right above and right below are large, the correlation map creating unit 142 adds a point (value) ‘1’ to the element; when the correlations of [the objective line] with both lines above and below are high, the unit 142 adds a point (value) ‘2’ to the element (block).

The labeling unit 143 searches the correlation map created by the correlation map creating unit 142 for the presence of a basic barcode symbol, which is a basic pattern (also called a mask pattern), while shifting on the elements on the map one by one (shifting in the horizontal scanning direction (the lateral direction) in this embodiment) and labels the area judged as having a basic barcode symbol.

In the basic pattern search processing at the labeling unit 143, a basic barcode pattern is searched in the correlation map. For example, assuming that a minimum size (unit) of a barcode to be detected corresponds to the pattern indicated by [2 2 2] on the correlation map, in which a value ‘2’ is consecutively labeled on three elements, when this mask pattern is detected through the search of the correlation map, a value ‘1’ is set in the map elements occupied by this pattern and a value ‘0’ in the rest of the map elements.

For searching the correlation map obtained by the correlation map creating unit 142 for the presence of a predetermined basic pattern and labeling, the labeling unit 143 of this embodiment judges whether the basic pattern is present or not, based on the ratio of the high correlation area to the area subject to judgment or the position of the high correlation area (high correlation value) in the basic pattern.

The meaning of the ratio of the high correlation area includes the case that the ratio of the number of a value ‘2’ to the number of the elements in the basic pattern is equal to or larger than a ratio set in advance.

Also, even if the sum of the element values of all the elements in the basic pattern is smaller than the sum of the element values acquired when all elements have high correlation, but if it is equal to or larger than a pre-set value, it can be set that the rate of the number of a value ‘2’, for example, to the number of the elements in the basic pattern is equal or larger than a rate set in advance.

The meaning of the position of the high correlation area in the basic pattern includes the case in which the element value of high correlation, a value ‘2’ for example, appears at both ends of the basic pattern, the case in which the high correlation element value ‘2’ appears consecutively more than a predetermined number of times (for example, 2, 3 or 4), and the case in which there are multiple positions (areas) where the value ‘2’ appears consecutively interposing one or more values, ‘1’ or/and ‘0’.

In this embodiment, the labeling unit 143 is configured to even recognize the pattern of [2 1 2] on the correlation map as a barcode symbol.

More specifically described, the labeling unit 143 does not look for a strict matching with the mask pattern [2 2 2], but pays attention to the ratio of a value ‘2’ occupying in the area subject to the mask pattern search.

For example, the conventional condition is that three map elements should all be provided with a value ‘2; however, if there are at least two of a value ‘2’, the labeling unit 143 of this embodiment judges that there is a barcode symbol pattern, and sets ‘1’ in the map elements occupied by the mask pattern and ‘0’ in the rest.

Alternately, the correlation map creating unit 142 may be configured to recognize the presence of a barcode symbol pattern if the sum of the element values of the mask pattern is equal to or larger than a predetermined value ‘2×5=10’. In this example, the sum of the element [values] of all the elements in the basic pattern is six or larger.

Alternately, the correlation map creating unit 142 may be configured, even if the sum of the element values of a mask pattern is smaller than a pre-set value ‘2×5=10’, which suggests uncertainty, to judge the uncertain mask pattern as a barcode symbol pattern as long as the sum of the element values of a basic pattern that follows after the shift is equal to or larger than the predetermined value ‘2×5=10’.

Alternately, the correlation map creating unit 142 may be configured to judge that there is a barcode symbol pattern if a value ‘2’ is set in the map elements at both ends of the basic pattern.

In other words, the labeling unit 143 may be configured to judge that there is a basic barcode symbol if the element value ‘2’ which indicates high correlation appears in predetermined positions in a predetermined form in the basic pattern composed of multiple elements.

The position determining unit 144 detects the position of the symbol information recorded on a medium, based on the area labeled by the labeling unit 143.

In the symbol position judgment processing by the position determining unit 144, [the judgment operation] starts with calculation of the center of gravity of the barcode map (ycog, xcog). The center of gravity is calculated according to the common definition.

Next, the position determining unit 144 calculates edge positions at the right, left, top and bottom of the barcode symbol. The position determining unit 144, using the center of gravity coordinate ‘xcog’ as the start point on the barcode map, detects the left and right edge positions within a horizontal extent as ‘xstart’ and ‘xstop’, at which the sum of the elements becomes zero (the range of calculation is ‘ycog±2’), and then terminates the detection operation. The top and bottom edge positions are detected within a vertical extent as ‘yupper’ and ‘ylower’, at which the sum of the elements becomes zero (the range of calculation is [xstart, xstop]), using ‘ycog’ as the start point on the barcode map and then the detection operation is terminated.

Thus, four sideline positions of the barcode symbol are identified on the lattice coordinate system.

Then, the position determining unit 144 calculates coordinates in an image space, based on the coordinates of the four sidelines.

In the symbol information reader 10 having such configuration, a medium 20 on which a barcode symbol 21 is printed is transferred along a transfer guide of a transfer mechanism 112; as passing by a 1D imaging element 111, the image of the card is photoelectrically converted; the image data is taken into an image memory 12 and stored there.

In the data processor 13, the image data containing the barcode symbol 21 is retrieved from the image memory 12 and various processing is applied on the retrieved image data.

In this embodiment, the position of the barcode symbol 21 printed on the medium 20 is detected by the position detection processing unit 14 in the data processor 13.

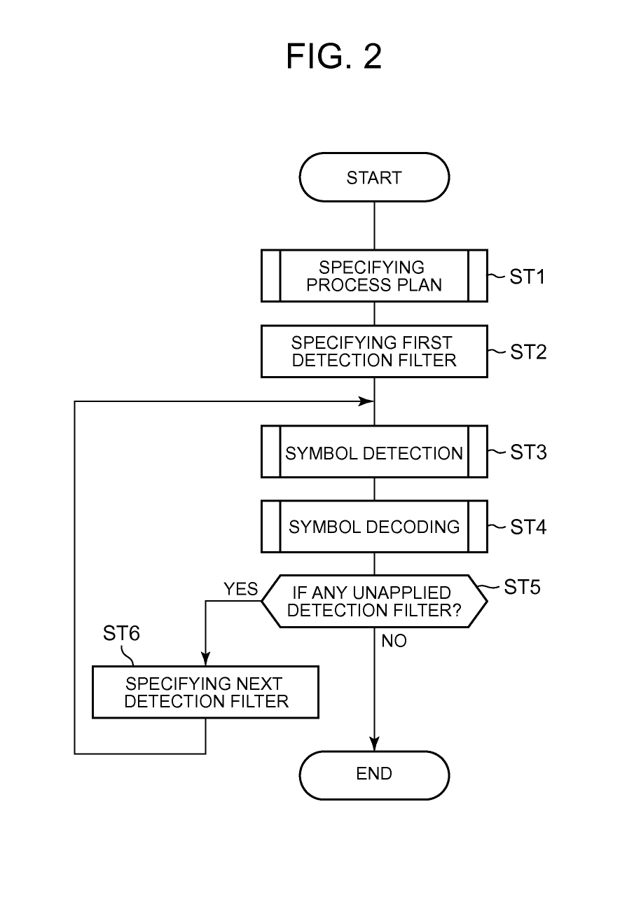

In the symbol information reader 10 of this embodiment, the decoding processing is applied on the barcode symbol according to a flowchart shown in FIG. 2.

The symbol information reading process of this embodiment is described in detail hereinafter with reference to the drawings.

### [Outline of Symbol Information Reading Processing]

FIG. 2 is a flowchart showing the workflow of the symbol information reading process of this embodiment of the present invention.

The workflow of the symbol information reading process according to the present embodiment is described with reference to FIG. 2.

First, a process plan is specified (Step ST1).

More specifically described, a type of barcode detector (a detection filter) and the application order are specified according to the type of the barcode symbol printed on the medium 20 or the type of a barcode symbol to be read.

Although a first detection filter (one of the basic barcode patterns described later) is specified by default (Step ST2), the application order may be changed depending on the appearing frequencies of barcodes, for example.

Then, a symbol detection is carried out (Step ST3).

More specifically described, by photoelectric conversion, the imaging element 111 of the symbol information reader 10 images the recording medium 2 containing the barcode symbol 21 that has moved along the card transfer mechanism (the transfer guide) 112 to a predetermined position. The captured image data containing the barcode symbol 21 is stored in the image memory 12.

Subsequently, the position detection processing unit 14 of the data processor 13 retrieves the image data stored in the image memory 12. Through processing operations of the variance map calculation by the temporary area judging unit 141, of the correlation calculations with respect to the lines above and below objective lines by the correlation map creating unit 142 of the basic pattern search by the labeling unit 143, and of the symbol position judgment by the position determining unit 144, the presence of the barcode symbol 21 is determined as a duty of the first detection filter described above. If the presence is identified, the position [of the barcode symbol] is determined.

Then, a decoding operation is carried out by the decoding processing unit 15 (Step ST4).

More specifically described, the decoding processing unit 15 of the data processor 13 implements decoding operation on the barcode symbol 21 (data decoding along the scanning lines L) based on the position of the barcode symbol 21 analyzed in Step ST3.

When there are any more barcodes to be detected, or in other words, there is any detection filter unapplied (Step ST5: YES), a next detection filter is applied (Step ST6) and the operation moves to Step ST3 for another symbol detection and symbol decoding (Step ST3 and Step ST4).

On the other hand, when there is no more detection filter unapplied (Step ST5: NO), a series of reading operations on the symbol information ends.

Note that an operation for switching the detection filters may be carried out, for example, by either the labeling unit 143 of the position detection processing unit 14 or the decoding processor 15. The switching order of the detection filters may be determined according to the appearing frequencies of barcodes, for example. These dispositions can increase efficiency of the reading process of symbol information.

The present embodiment includes the steps of specifying the process plan (Step ST1) and renewing the detection filter (Step ST6), considering a possibility that one media may contain multiple kinds of barcodes. However, these steps can be omitted, and the process may be completed only with Step ST3 and Step ST4 instead.

### [Specific Operation of Symbol Detection]

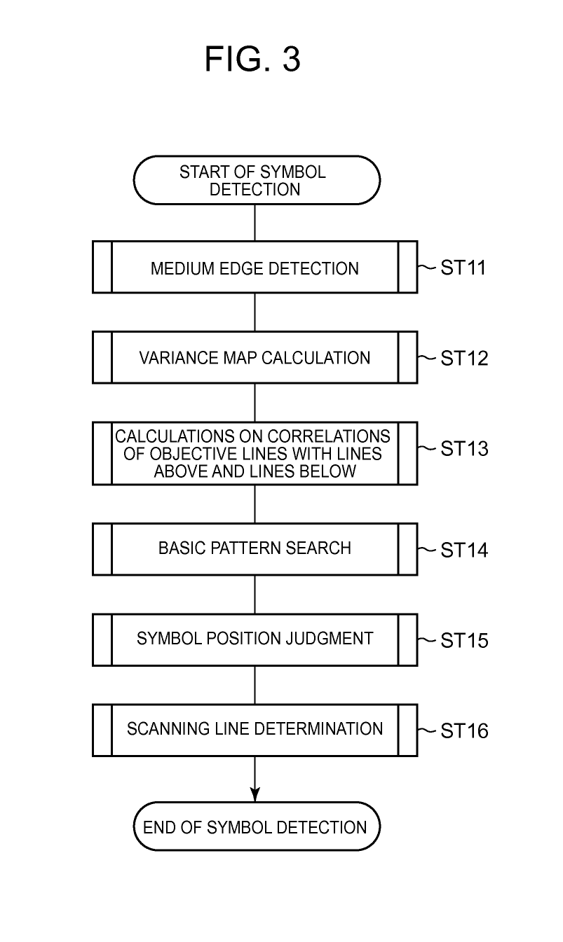

FIG. 3 is a flowchart showing the workflow of information processing in symbol detection by Step ST3 of FIG. 2.

In FIG. 3, edge positions at the top, bottom, right and left of the medium 20 are detected at first (Step ST11).

More specifically described, the temporary area judging unit 141 detects the edge positions at the top, bottom, right and left as preprocessing for variance map calculation, using the image data of the medium 20 stored in the image memory 12.

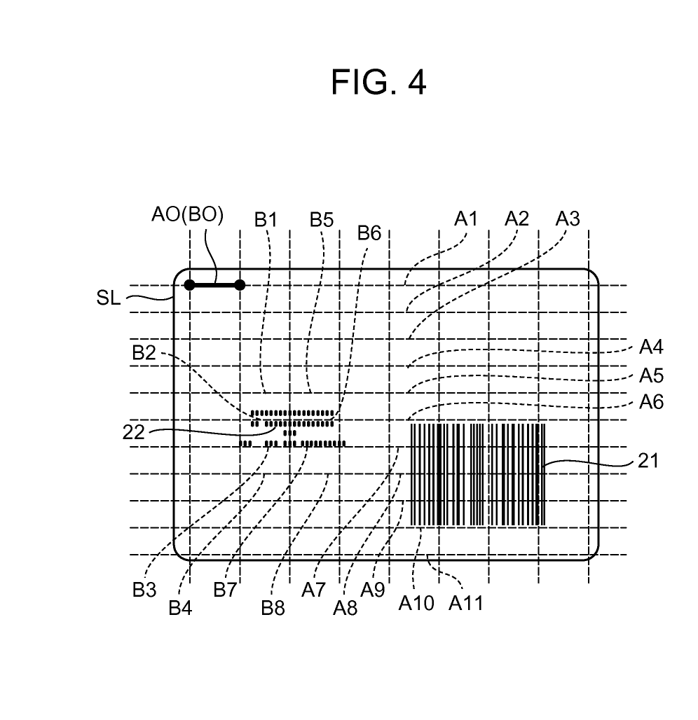

FIG. 4 shows an example of the image data of the medium 20 stored in the image memory 12.

In FIG. 4, a solid line SL outlining the medium 20 shows the edge positions of the medium 20, acquired by the edge detection.

Next, a variance map calculation is carried out at the temporary area judging unit 141 (Step ST12).

More specifically described, the temporary area judging unit 141 segments the whole image space into a lattice arrangement of small blocks by using the edge lines as baselines as FIG. 4 shows, and calculates brightness changes (for example, variance or standard deviation) along a line in each block.

The line in each block is formed in the same direction as the scanning direction of the scanning line L for the barcode symbol 21 shown in FIG. 1, and it is, for example, a line indicated by code A0 (B0) shown in FIG. 4.

While multiple lines are specified in each block, and differential operation first and then product-sum operation are carried out for each corresponding point in the conventional technology, a variance (or standard deviation) is computed for the data on each line in the symbol information reading process of this embodiment.

Therefore, compared with the conventional technology, the method for reading symbol information of this embodiment requires fewer computations.

As a result of the same calculation for all the lattice blocks, a map on the amount of [brightness] change based on the lattice coordinates can be obtained.

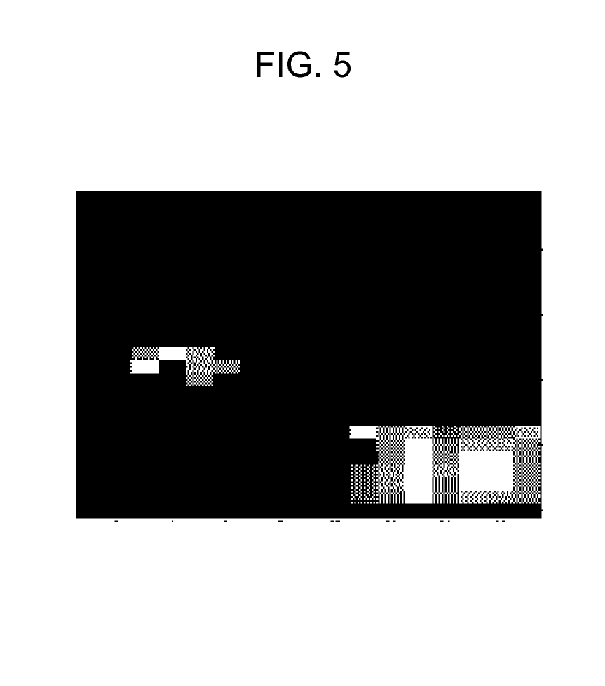

FIG. 5 shows the map values expressed by an image.

White sections represent blocks having large change while black sections represent blocks having small change. The sections having large change correspond to the position of the barcode symbol 21 shown in FIG. 4.

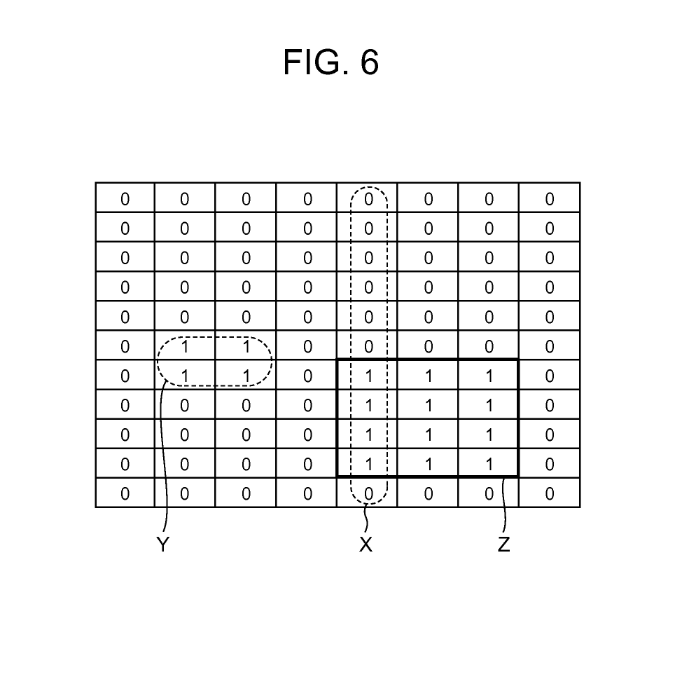

Binarization of the map of FIG. 5 results in the data shown in FIG. 6. As a threshold for binarization, an appropriate value can be specified on the basis of the distribution of the amount of [brightness] change.

FIG. 6 is a result of binarizing the map of FIG. 5.

FIG. 6 is described below in detail.

For example, on the fourth column from the right end of the map of FIG. 6, number values are arranged in the order of [0,0,0,0,0,0,1,1,1,1,0] from the top (in the section circled with dotted line X). This corresponds to the result of binarizing the variance of each single line, A1 to A11 in FIG. 4, with a predetermined threshold.

FIG. 6 shows that a value ‘1’ is set in twelve blocks which form a rectangle area (the area indicated with bold line Z) (one of the columns [in this rectangle] has A6, A7, A8 and A9 of in FIG. 4) which corresponds to the position of the barcode symbol 21 of FIG. 4.

Thus, the temporary area judging unit 141, which detects the positions of the top, bottom, right and left edges (Step ST11 in FIG. 3) and calculates a variance map (see FIGS. 5 and 6) (Step ST12 of FIG. 3), calculates brightness changes along the scanning lines in a predetermined area of the image data and judges (identifies) a temporary area having a possibility of corresponding to the symbol information.

The “temporary area” described above corresponds to the area Z consisting of twelve blocks, each of which is provided with a value ‘1’, as described above.

In the map of binarized [variance] shown by FIG. 6, the section of the image corresponding to the blocks provided with a value ‘1’ has a high probability of matching with the barcode area, but it may not necessarily be the barcode area.

In other words, there exists an area Y which does not contain the barcode symbol 21 but has blocks with ‘1’. Such an area has a chance of being judged as a “temporary area”.

More specifically described, the four blocks with ‘1’ existing in the section circled with dotted line Y correspond not to the area in which the barcode symbol 21 is positioned but to a position of characters printed on the surface of the medium 2, as FIG. 4 shows.

To solve the problem, correlation calculations with respect to the lines above and below objective lines are carried out in Step ST13 of FIG. 3.

The step by the correlation map creating unit 142 discriminates the area of the barcode symbol 21 from the rest.

More specifically described, with respect to each element provided with a value ‘1’ on the lattice map, correlations on brightness of the lines mutually shared by the corresponding block (line) and the neighboring blocks (lines) right above and right below it are calculated.

If the blocks (lines) contain the barcode symbol 21, the correlation value must be a large value.

More specifically, the correlation map creating unit 142 creates a line correlation map on the lattice coordinate system.

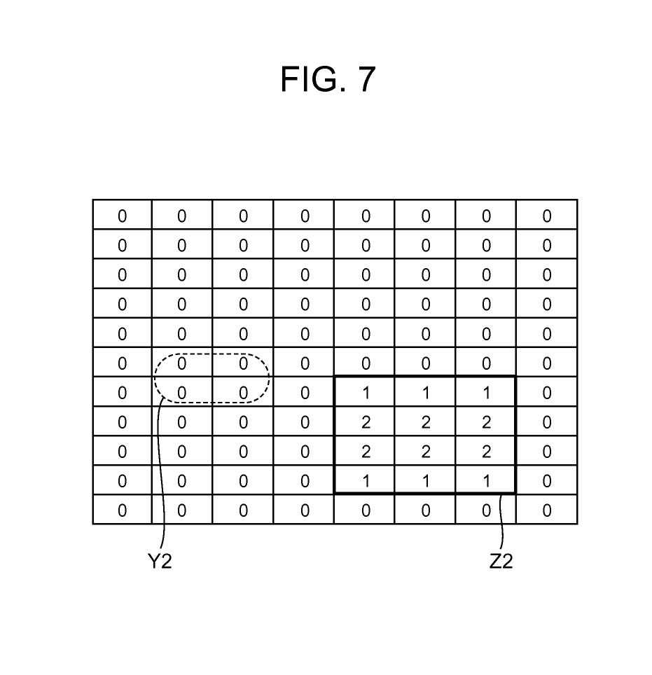

FIG. 7 shows a correlation map which is a calculation result of correlations with the lines above and below objective lines.

More specifically described, with respect to the lines formed parallel to the scanning direction of the scanning line for the barcode symbol 21, when the correlation value of an objective line with either the line above or the line below is large, a value (point) ‘1’ is added to the element; when the correlation values of an objective line with both the line above and the line below are large, a value (point) ‘2’ is added to the element.

One caution to be considered on this occasion is that the objective data is not the data shown in FIG. 6 (binary data by ‘0’ and ‘1’), but the image data shown in FIG. 4 is the one.

For example, the four lines, namely B2, B6, B3 and B7 in FIG. 4, are used to generate points (values) in four elements circled with dotted line Y in FIG. 6. These four lines are objective lines [respectively] here.

The correlation calculations of the line B2 with the line above and the line below is carried out by calculating a correlation value between B2 and B1 as well as a correlation value between B2 and B3. When one of these two values is large enough, a point (value) ‘1’ is set. When both of the two values are large enough, a point (value) ‘2’ is set.

The correlation values of any character area are generally not large, compared to those of the area of the barcode symbol 21 (therefore, a threshold, used to determine whether a correlation value is large enough or not, is so defined as to make it possible to identify the area of the barcode symbol 21).

In the same manner, the correlation calculations of the line B6 shown in FIG. 4 with the line above and the line below are carried out by calculating a correlation value between B6 and B5 as well as a correlation value between B6 and B7; the correlation calculations of the line B3 with the line above and the line below are carried out by calculating a correlation between B3 and B2 as well as a correlation between B3 and B4; the correlation calculations of the line B7 with the line above and the line below are carried out by calculating a correlation value between B7 and B6 as well as a correlation value between B7 and B8. The result is that none of these correlation values are large.

Consequently, as shown by a section circled with dotted line Y2 in FIG. 7, the point (value) set in each block circled with dotted line Y in FIG. 6 is ‘0’.

In the same manner, the lines used to generate points (values) in twelve elements enclosed by bold line Z in FIG. 6 are the twelve lines including the area of the barcode symbol 21 in FIG. 4.

For example, the four lines, namely A7 to A9 in FIG. 4, are used to generate points (values) in the left column in the solid frame Z2 shown in FIG. 7 (a section of [1, 2, 2, 1] from the top). The correlation calculations of the objective line A7 with the line above and the line below are carried out by calculating a correlation value between A7 and A6 as well as a correlation value between A7 and A8. Due to characteristics of the barcode symbol 21, the correlation value between A7 and A8 is significantly large (being almost close to 1).

As a result, a point (value) ‘1’ is added. The correlation calculations of the objective line A9 with the line above and the line below are carried out in the same manner, and a point (value) ‘1’ is added in the same manner. The correlation calculations of the objective line A8 with the line A7 above and the line A9 below are carried out in the same manner; however, both correlation values become significantly large and therefore a point (value) ‘2’ is added.

In this way, each point of [1, 2, 2, 1] is set for the left column enclosed by bold frame Z2. Each point of [1, 2, 2, 1] in the middle column and each point of [1, 2, 2, 1] in the right column in the bold frame Z2 are set in the same manner.

As FIG. 7 shows, an element provided with a point (value) ‘2’ indicates that it has significant vertical correlations. Such an element is relevant to the characteristics of a barcode in which the same line patterns are vertically stacked, and it is considered to have a high probability of conforming to a barcode area.

Thus, the correlation map creating unit 142 for implementing correlation calculations of objective lines with the line above and the line below (Step ST13 of FIG. 3) calculates correlations of the above-mentioned temporary area with the neighboring areas adjacent in a direction perpendicular to the scanning direction (in the vertical direction in FIGS. 4 and 6) of the scanning lines for the barcode symbol 21 (refer to code L in FIG. 1), and creates a map that show the areas of large correlation value.

In this embodiment, as explained by referring to the section enclosed by bold frame Z2 in FIG. 7, the correlations [of the temporary area] with two neighboring areas adjacent in the top-bottom direction (i.e., the line above and the line below) are calculated. Then, a correlation map is created while differentiating a first case in which each of the two correlation values is larger than a predetermined threshold (the case where a point (value) ‘2’ is added) from a second case in which either one of the two correlation values is larger than the predetermined threshold (the case where a point (value) ‘1’ is added).

In this manner, a correlation map can be created to accurately recognize the position of the barcode symbol 21 (refer to FIG. 7).

Next, a basic pattern search is carried out at the labeling unit 143 (Step ST14 of FIG. 3).

More specifically described, the labeling unit 143 searches the correlation map for the presence of a basic barcode pattern. For example, under the condition where the minimum size of a barcode to be detected corresponds to a mask pattern (a row of points) of [2, 2, 2] in the scanning direction on the correlation map, the labeling unit 143 searches the correlation map of FIG. 7; when the mask pattern of [2, 2, 2] is detected, a point (value) ‘1’ is set in each of the map elements occupied by the mask pattern and ‘0’ in any other elements.

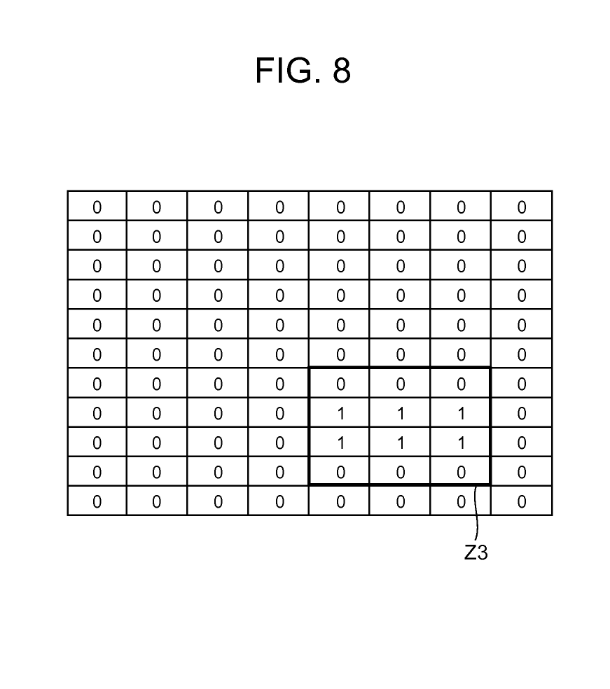

This operation on the correlation map shown in FIG. 7 results in a barcode map shown by bold frame Z3 of FIG. 8.

FIG. 8 is a barcode map resulted from the correlation map shown in FIG. 7.

Thus, the labeling unit 143 for implementing a basic pattern search (Step ST14 of FIG. 3) searches the correlation map for the presence of a basic barcode of a basic pattern (the mask pattern [2, 2, 2] described above in this embodiment, for example) and labels the area judged as having the basic barcode (setting a point ‘1’ in each of the map elements).

Note that, as described later, for searching the correlation map acquired at the correlation map creating unit 142 for a predetermined basic pattern and labeling, the labeling unit 143 of this embodiment judges whether the basic pattern is present or not, based on the ratio of the high correlation areas (the elements with a value ‘2’ in this embodiment) to the area subject to judgment or the position [of the high correlation area] in the basic pattern.

Note that, although in this embodiment a mask pattern is consisting of three elements, the type of “basic barcode” (basic barcode pattern) can be varied to a mask pattern having four elements, five elements, six elements or more in a single row, or a mask pattern composed of six elements laid out, three in the upper row and thee in the lower row each.

Furthermore, in this embodiment, the correlations of an objective line with the areas (i.e., lines) neighboring in the direction perpendicular to the scanning direction of the scanning lines are calculated; then, the area in which each of two correlation values is larger than a predetermined threshold is labeled as an area judged has having the basic barcode.

With any character areas being excluded appropriately in this way, areas having a higher probability (only the area where the barcode symbol 21 exists) can be a subject to the search.

The labeling unit 143 of the position detection processing unit 14 stores one or more basic barcode patterns (detection filters).

Then, the basic barcode pattern changes sequentially in a series of symbol information reading operations as already described with reference to the flowchart of FIG. 2 (Step ST5 and ST6 of FIG. 2). Consequently, the labeling unit 143 implements the basic pattern search using multiple basic barcode symbol patterns.

Next, a symbol position judgment is made at the position determining unit 144 (Step ST15 of FIG. 3).

More specifically described, the judgment operation by the position determining unit 144 starts with calculating the center of gravity of the barcode map (ycog, xcog) (the center of gravity is calculated according to the common definition). Subsequently, the edge positions at the right, left, top and bottom of the barcode are acquired. The left and right edge positions are detected within a horizontal extent shown in FIG. 8 as ‘xstart’ and ‘xstop’, at which the sum of the elements becomes zero (the range of calculation is ‘ycog±2’) using ‘xcog’ as a starting point on the barcode map and then the detection operation is terminated.

The top and bottom edge positions are detected within a vertical extent as ‘yupper’ and ‘ylower’, at which the sum of the elements becomes zero (the range of calculation is [xstart, xstop]) using ‘ycog’ as a starting point on the barcode map and then the detection operation is terminated.

Thus, four sideline positions of the barcode symbol 21 are identified on the lattice coordinate system. Then, coordinates in an image space are acquired according to the coordinates of the four sidelines.

Each lattice block has a corresponding relationship to the image space, and the left edge BCDL of the barcode symbol is a block staring point of a block (ycog, xstart). The right edge BCDR of the barcode symbol is a block ending point of the block (ycog, xstop). Therefore, the horizontal extent of the barcode symbol is from BCDL to BCDR.

Incidentally, the horizontal extent can be expanded for a distance of a certain number of pixels to the right and left direction as margin. The top and bottom edge positions of the barcode symbol in the image space are calculated according to the profile of average brightness within an area interposed between the y-coordinate of the block (yupper, xcog) and the y-coordinate of the block (ylower, xcog).

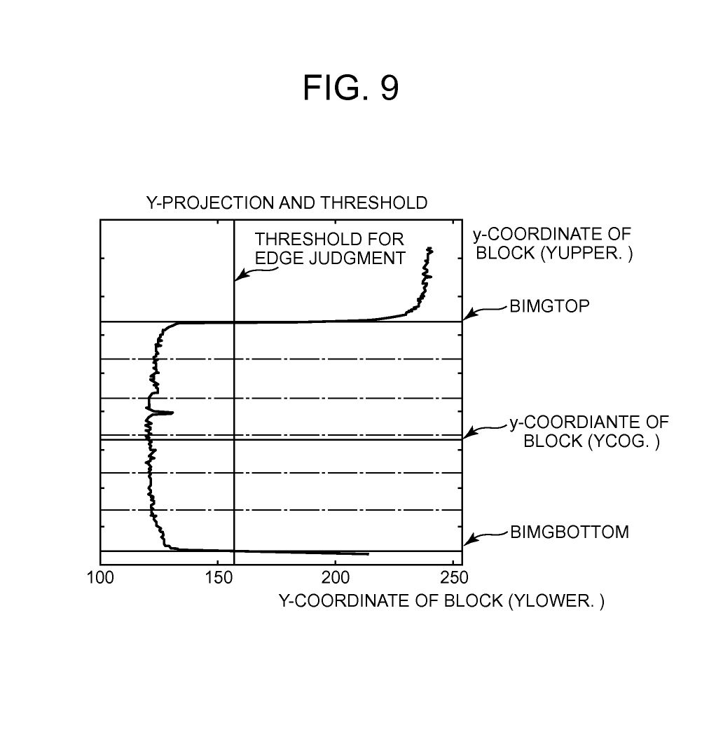

FIG. 9 specifically shows an example (when profiles are calculated for all areas without using the barcode map shown in FIG. 8, a certain amount of computation and calculation time is required).

FIG. 9 shows a profile of average brightness in the vicinity of the barcode symbol 21.

As shown in FIG. 9, a starting point for searching the top and bottom edges is located at the y-coordinate of the block of the center of gravity, and a threshold for edge identification is determined according to the brightness of this block (see FIG. 9).

In searching for edges in a vertical direction, the positions at which the brightness value exceeds the threshold are judged as the edges as ‘Bimgtop’ and ‘Bimgbottom’.

Thus, the position determining unit 14 detects the position of the barcode symbol 21 printed on the medium 20 according to the labeled area Z3 as shown in FIG. 8.

Also, the position determining unit 144 may be configured to have a function of identifying the symbol position to determine the positions of the top, bottom, left and right edges of the barcode symbol printed on the medium 20 based on the labeled area, to count the total number of labeled elements in a rectangular area formed by those positions, to judge whether the counted total number agrees with the total number of labeled elements in the entire correlation map which is counted in advance, and subsequently to detect the position of the barcode symbol 21 printed on the medium 20. As a result, accuracy of the [edge] positions of the top, bottom, left and right can be improved.

Basically, the symbol information reader is capable of determining the position of the barcode symbol on the image space by determining the edges as ‘Bimgtop’ and ‘Bimgbottom’; therefore, it is possible for the device to end the entire operation of the barcode symbol position detection here.

However, there may be a case in reality that, depending on the printing condition of a barcode symbol or uncleanness of a medium base material, a pattern matching with [2, 2, 2] may not be created on the correlation map regardless of the presence of the barcode symbol pattern.

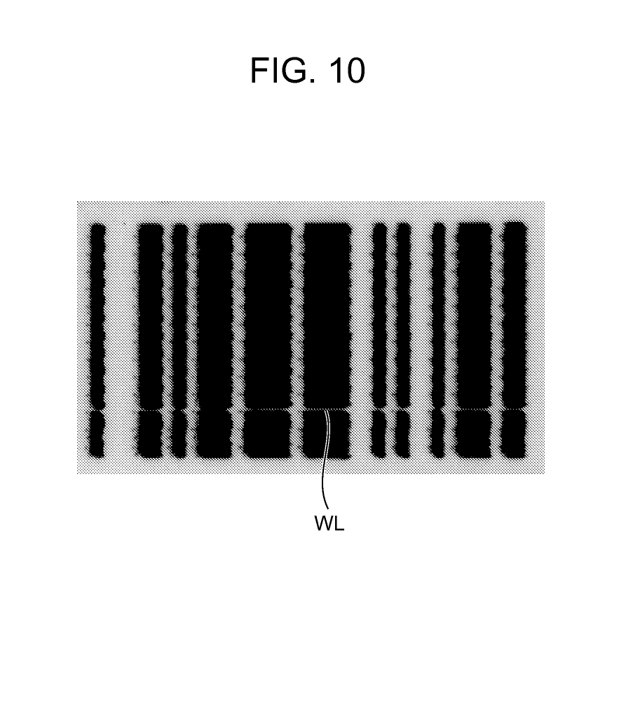

FIG. 10 shows an example in which a white seam line (on medium) overlaps the position of one of the two lines (the line above or the line below the objective line).

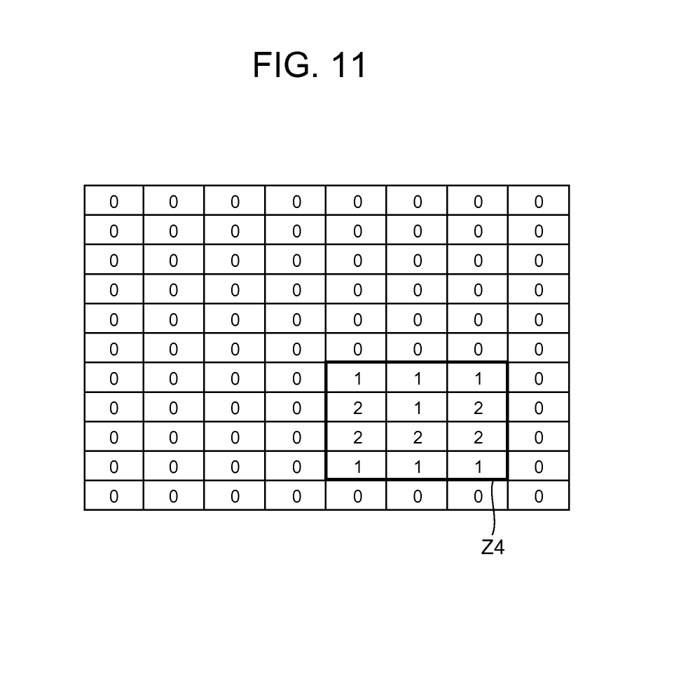

FIG. 11 shows an example of a correlation map created when a white seam line overlaps the position of one of the two lines (the line above or the line below the objective line).

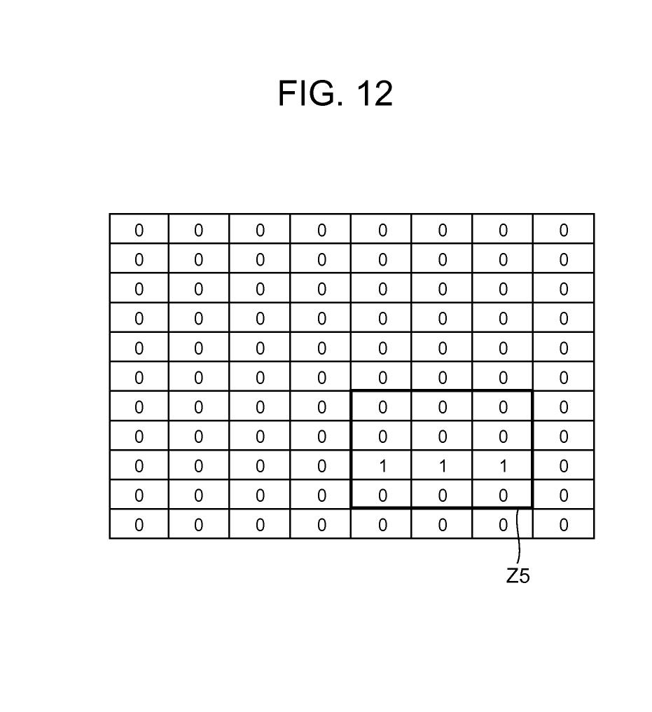

FIG. 12 shows a result that a basic pattern search operation is applied to the correlation map of FIG. 11.

The agreeing pattern may not be created when either line above or below or both lines are hindered from being a complete barcode symbol, as shown in FIG. 10.

When the white seam line WL overlaps the position of one of the two lines (above or below the objective line), the correlation value of such line is small in the correlation calculations of objective line with the line above and the line below by the correlation map creating unit 142, as shown in the correlation map of FIG. 11.

An ideal correlation map should be, as shown by four rows enclosed by bold line Z2 of FIG. 7, [1 1 1], [2 2 2], [2 2 2], [1 1 1] from the top; however, the pattern in reality is [1 1 1], [2 1 2], [2 2 2], [1 1 1] in FIG. 11.

With the basic pattern search processing applied, the pattern results in that of FIG. 12 where no barcode symbol pattern can be detected.

In other words, an ideal pattern should result in [0 0 0], [1 1 1], [1 1 1], [0 0 0] from the top with the basic pattern search processing applied, as shown by four rows enclosed by bold line Z3 of FIG. 8; however, the pattern in reality results in [0 0 0], [0 0 0], [1 1 1], [0 0 0] as shown in FIG. 12.

In this example, the second row [2 1 2] in bold frame Z4 is labeled as [0 0 0] [in FIG. 12]. This line is not recognized as a barcode symbol.

To prevent [mislabeling], the symbol information reader 10 of this embodiment is configured to recognize the pattern of [2 1 2] on the correlation map as a barcode symbol.

More specifically described, a precise agreement with the mask pattern [2 2 2], which is a basic pattern, is not sought, but the ratio of a value ‘2’ occupying the areas subject to the mask pattern search is more weighed.

For example, when a basic pattern consists of three map elements, a conventional condition has been that there should be three elements having a value ‘2’ that indicates a high correlation area.

In this embodiment, [on the other hand,] if there are at least two elements having a value ‘2’ that indicates a high correlation area, it is regarded that a barcode symbol pattern exists, and a value ‘1’ is set in the map elements occupied by the mask pattern and a value ‘0’ in the rest.

With such a configuration, even if the correlation map is the one as shown in FIG. 11, the acquired barcode map is the same one as shown in FIG. 8, thus preventing the barcode symbol from being missed.

### [Position Detecting Operation by Symbol Information Reader]

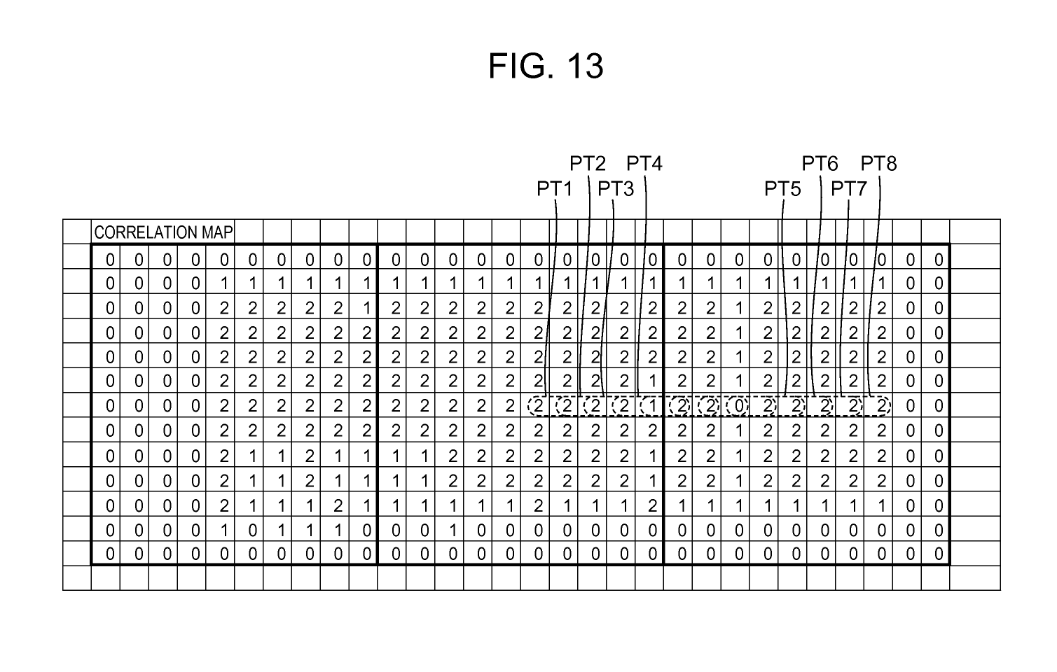

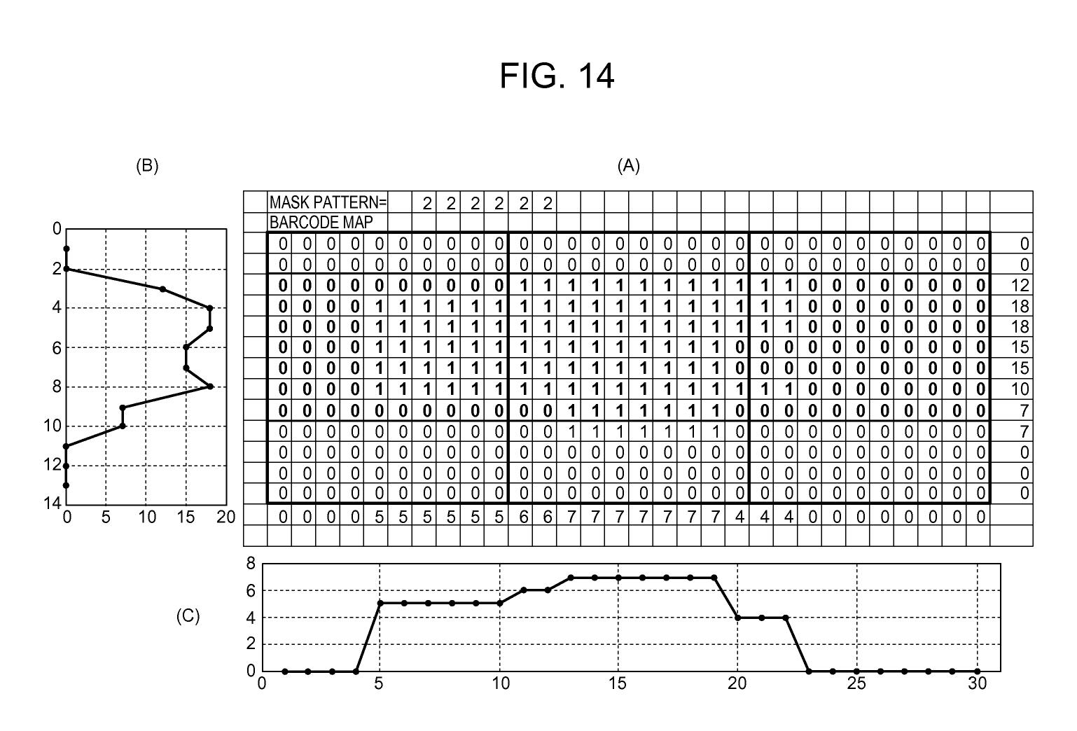

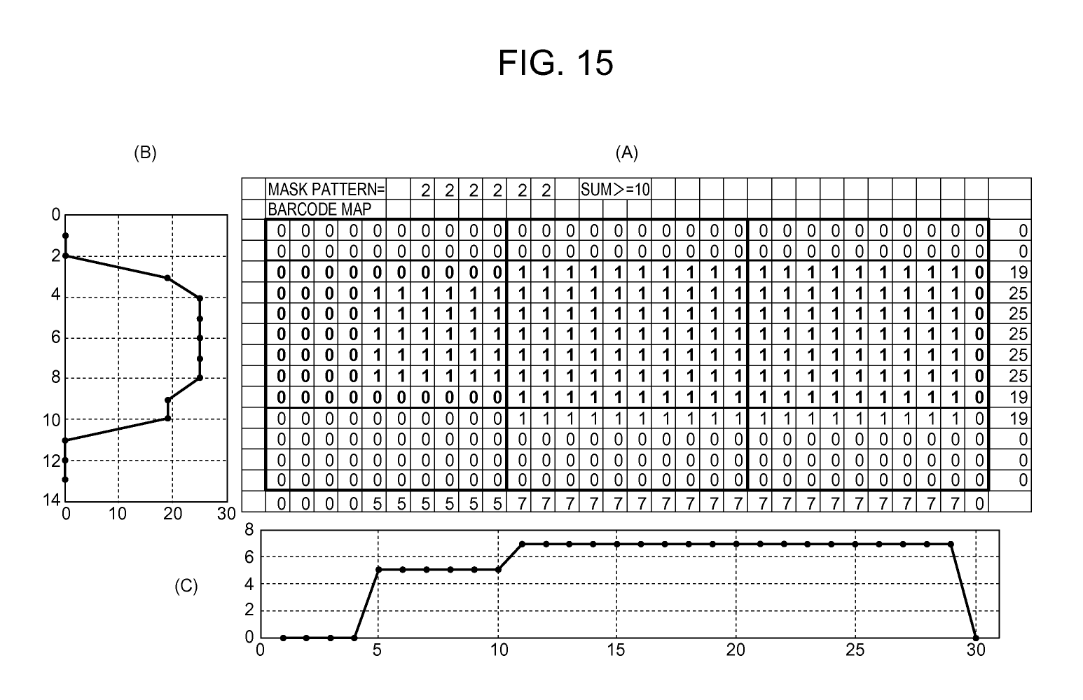

Next, more concrete position detecting operation by the symbol information reader of this embodiment is described with reference to FIG. 13, FIG. 14 and FIG. 15. [FIG. 68]

FIG. 13 shows an example of a correlation map formed in a matrix of ‘13 rows×30 columns’.

FIG. 14 shows a barcode map resulted from labeling when a precise agreement with a predetermined mask pattern is sought in the basic pattern search, as in an existing symbol information reader.

FIG. 15 shows a barcode map resulted from the labeling in the basic pattern search in the symbol information reader of this embodiment, when the presence of a basic pattern is determined if the sum of the element values of the entire elements in the basic pattern is equal to or larger than a predetermined value.

In FIG. 14 and FIG. 15, (B) shows a profile of average brightness in the vicinity of the barcode symbol 21 and (C) shows a distribution condition of the labeling value ‘1’ in the map which is searched as the barcode symbol area.

In this example, the basic pattern consists of six consecutive elements.

In the example of FIG. 14, the processing is implemented recognizing a barcode symbol pattern only when all the six map elements are set with a value “2” and its sum is 12.

In the example of FIG. 15, the processing is implemented recognizing a barcode symbol pattern even when the six map elements are not set with only a value ‘2’ but with values including ‘1’ and a ‘0’ and therefore the sum of these element values is not ‘12’ but a predetermined value ‘10’ (alternately could be ‘9’ which is less than ‘10’).

In this case, a barcode symbol pattern is recognized if the number of a value ‘2’ indicating high correlation area is equal to or larger than a predetermined ratio, i.e., at least five elements out of six elements; if the value is smaller than a value ‘2’ or the number of a value ‘2’ is less than five, it is not regarded as a barcode symbol pattern, but considered as uncertain at first and may be judged as a barcode symbol pattern depending on the state of the following pattern or the position of the high correlation value in the basic pattern.

Even in this case, the basic pattern search is carried out primarily such that while the elements are being shifted one by one in the horizontal direction (in the right lateral direction in the figure) on the map, a basic pattern area is created; a judgment is made on every basic pattern area whether the sum of the element values is ‘12’ or ‘10’ or more.

The map of FIG. 14 is a barcode map acquired by an existing method, having the basic pattern to be [2 2 2 2 2 2] with respect to the correlation map of FIG. 13.

As a result of the symbol position search by the position determining unit 144, ‘xstart=4’ and ‘xstop=23’ can be acquired.

Since ‘xstop=23’ is located more to the left than the right edge position (xstop=30) of the actual barcode, the entire barcode symbol cannot be segmented.

On the other hand, according to this embodiment, it is regarded that a barcode symbol pattern is present if the total of the element values of the mask pattern is ‘2×5=10’ or more, and therefore, the barcode map of FIG. 15 can be acquired.

In this case, the symbol position search by the position determining unit 144 results in ‘xstart=4’ and ‘xstop=30’, making it possible to segment the entire barcode symbol correctly.

In the processing of this embodiment, the six element pattern shown by pattern PT1 in FIG. 13 is [2 2 2 2 1 2] and its sum value is ‘11’; therefore, it is regarded that a barcode symbol is present. In this case, the number of the elements set with a value ‘2’ that indicates high correlation area is five out of six elements, and is equal to or more than a predetermined ratio.

The six element pattern shown by pattern PT2, which is the one with one element shifted from PT1, is [2 2 2 1 2 2] and its sum value is ‘11’; therefore, it is regarded that a barcode symbol is present.

The six element pattern shown by pattern PT3, which is the one with one further element shifted from PT2, is [2 2 1 2 2 0] and its sum value is ‘9’; therefore, it is considered uncertain whether a barcode symbol pattern is present or not.

The six element pattern shown by pattern PT4, which is the one with one further element shifted from PT3, is [2 1 2 2 0 2] and its sum value is ‘9’; therefore, it is considered uncertain whether a barcode symbol pattern is present or not.

The six element pattern shown by pattern PT5, which is the one with one further element further shifted from PT4, is [1 2 2 0 2 2] and its sum value is ‘9’; therefore, it is considered uncertain whether a barcode symbol pattern is present or not.

The six element pattern shown by pattern PT6, which is the one with one further element shifted from PT5, is [2 2 0 2 2 2] and its total sum is ‘10’; therefore, it is regarded that a barcode symbol pattern is present.

The six element pattern shown by pattern PT7, which is the one with one element further shifted from PT6, is [2 0 2 2 2 2] and its sum value is ‘10’; therefore, it is regarded that a barcode symbol pattern is present.

The six element pattern shown by pattern PT8, which is the one with one further element shifted from PT7, is [0 2 2 2 2 2] and its total value is ‘10’; therefore, it is regarded that a barcode symbol pattern is present.

In this embodiment, the patterns PT3, PT4 and PT5 that were considered uncertain at first can be judged not uncertain but that a barcode symbol is present because of the following reason: the patterns PT6 through PT8 resulted from the shifting by one element from the patterns PT3, PT4 and PT5 respectively are judged that there is a barcode symbol pattern.

Although the pattern PT4 considered uncertain is [2 1 2 2 0 2] and its sum value is ‘9’, a value ‘2’ that indicates high correlation area appears at both ends of the pattern; as a result, it is judged not uncertain but that the barcode symbol pattern is present.

As described above, in this embodiment, the correlation map creating unit 142 judges that a barcode symbol pattern is present if the sum of the element values of the mask pattern is equal to or larger than a predetermined value ‘2×5=10’, which is smaller than the sum of the element values ‘12’ indicating that all the elements have a high correlation value.

Also, the correlation map creating unit 142 judges an uncertain mask pattern as the barcode symbol pattern even if the sum of the element values of the mask pattern is smaller than a predetermined value ‘2×5=10’, as long as the sum of the element values of the following basic pattern after the shift is equal to or larger than the predetermined value ‘2×5=10’.

Further, the correlation map creating unit 142 judges that a barcode symbol pattern is present if a value ‘2’ appears at both ends of the basic pattern.

### [Primary Advantageous Effect of the Embodiment]

As described above, according to the symbol information reader of this embodiment, when searching the correlation map acquired by the correlation map creating unit 142 for a predetermined pattern and labeling, the labeling unit 143 judges whether a basic pattern is present or not, according to the ratio of high correlation areas to a [whole] area subject to judgment or the position of the value indicating high correlation area in the basic pattern.

The ratio of high correlation area here includes the case in which the ratio of the number of the element value, ‘2’ for example, which indicates high correlation, to the [total] number of the elements in the basic pattern is equal to or larger than a predetermined ratio.

Even if the sum of the element values of all the elements in the basic pattern is equal to or larger than a predetermined value, but if it is smaller than the sum of the element values when all the elements are of high correlation, the ratio of the number of the element value, ‘2’ for example, which indicates high correlation, to the [total] number of elements in the basic pattern is equal to or larger than a predetermined ratio.

The position of high correlation area in the basic pattern includes the case in which the element value, ‘2’ indicating high correlation, for example, appears at both ends of the basic pattern composed of multiple elements, the case in which the element value ‘2’ that indicates high correlation consecutively appears more than a specified number of times (2, 3, 4, etc., for example), and the case in which there are multiple positions (areas) [of ‘2’] that are interposing one or more of the value ‘1’

Therefore, according to this embodiment, the following effects can be acquired.

Since, in the past, a strict agreement between [a pattern] on a correlation map and a predetermined mask pattern ([2 2 2], for example) was required during a barcode symbol pattern search, there were cases that a pattern agreeing with [2 2 2] could not be formed on the correlation map due to the printing condition of the barcode symbol or uncleanness of a medium base even if a barcode symbol was substantially present. This has led to detection failure of the barcode symbol sometimes.

Then, paying attention to the ratio of high correlation index (‘2’ in this embodiment) to the area subject to mask pattern search, if at least two out of three map elements are set with a value ‘2’, it is regarded that a barcode symbol pattern is present, thus avoiding overlooking of a barcode.

Also, in this embodiment, if the sum of the element values of a mask pattern is equal to or larger than a predetermined value ‘2×5=10’, it can be regarded that a barcode symbol pattern is present.

Even if the sum of the element values of a mask pattern is less than a predetermined value ‘2×5=10’, but if the sum of the element values of the following basic pattern obtained after the shifting [by one element] is equal to or larger than the predetermined value ‘2×5=10’, the correlation map creating unit 142 regards that the uncertain mask pattern has a barcode symbol pattern.

Also, if a value ‘2’ is set in the map elements at both ends of the basic pattern, the correlation map creating unit 142 judges that a barcode symbol pattern is present.

In other words, according to this embodiment, misjudgment can be prevented when symbol information such as a barcode symbol pattern is read, enabling accurate reading of the entire symbol information.

Further, according to this embodiment, the top, bottom, left and right [edge] positions of the barcode symbol 21 can be determined without differential operations, and consequently computations can be reduced.

Reduced computations can contribute to shortening the processing time. Furthermore, if sufficient operation speed is obtained even with an inexpensive imaging element, an inexpensive imaging element can be used instead of an expensive one, contributing to reducing manufacturing cost.

### Application Examples

At least an embodiment of the present invention can also be applied to a position detection of a typical 2D barcode, PDF417.

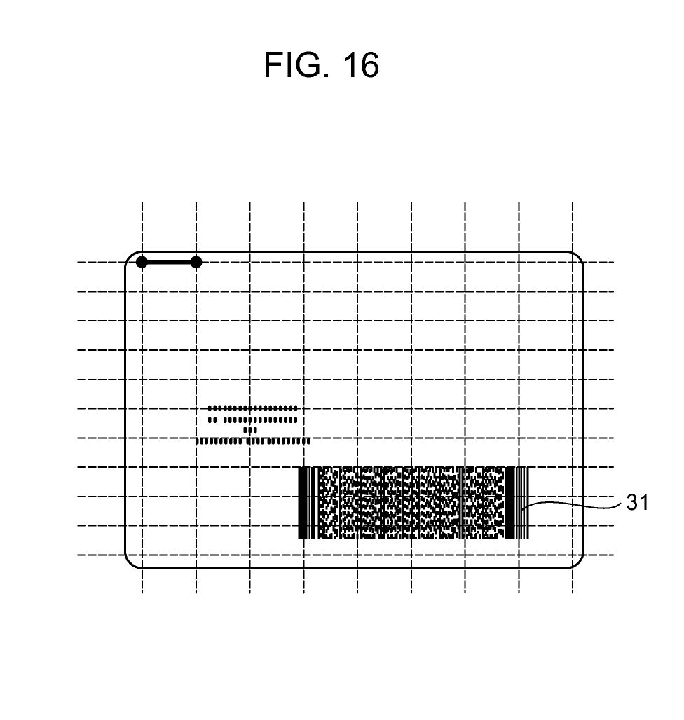

FIG. 16 shows an example of an image of a medium on which a 2D barcode 31 is printed.

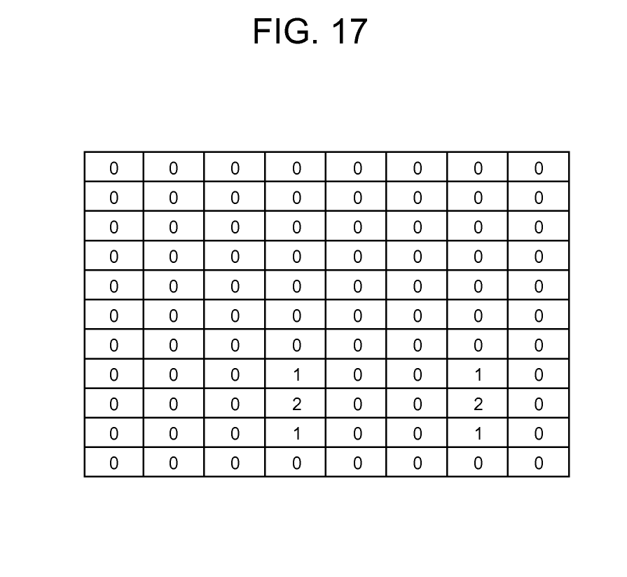

Applying the above-described processing steps of position detection to the image shown in FIG. 16 results in a correlation map of the lines as shown in FIG. 17.

While a value (point) ‘2’ appears in the entire symbol area for the case of a 1D barcode (refer to FIG. 8), a value (point) ‘2’ appears only in the elements corresponding to the left end and right end [of the barcode] and a value ‘0’ appears in the elements in the middle in the correlation map of FIG. 17.

In the case of a 2D barcode, the above-described mask pattern search operation cannot detect the 2D barcode. Therefore, the search operation of a 1D barcode is temporarily terminated, and a search operation assuming that a 2D barcode exists is carried out starting with the correlation map.

In other words, a pair of similar patterns at the right and left ends are searched for in the correlation map. After the pair of patterns are once detected, the rectangular area interposed between the patterns is mapped on the image space coordinate system so as to determine the barcode position according to the characteristics of the 2D barcode symbol.

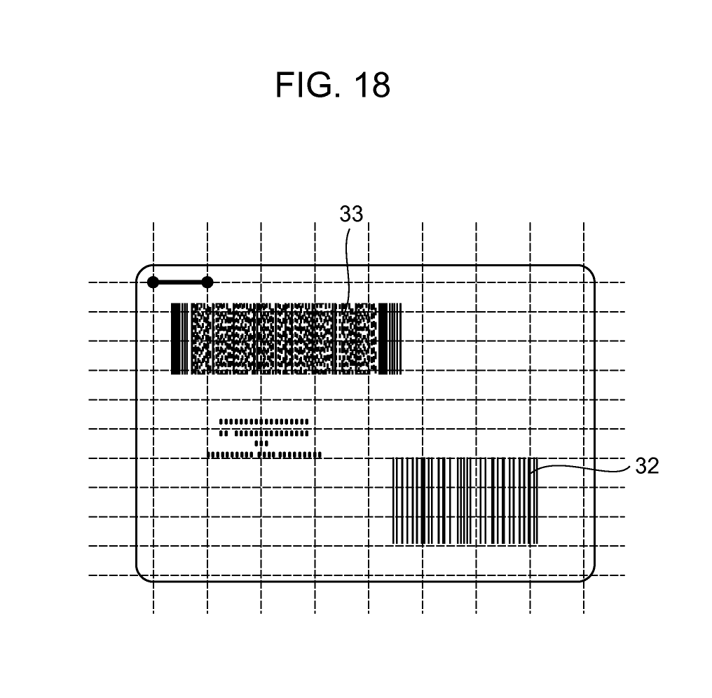

FIG. 18 shows an example in which multiple kinds of barcode symbols are used on a single medium.

As shown in FIG. 18, the medium includes a 1D barcode symbol CODE128 (indicated by code 32) and a 2D barcode PDF417 (indicated by code 33). A symbol detector for each type of barcode is prepared in advance, and a symbol detector prepared for CODE128 is used first for the input image.

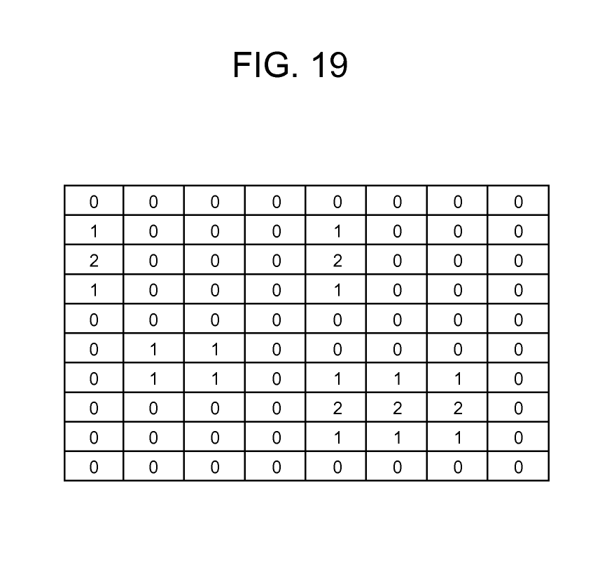

A correlation map for FIG. 18, corresponding to the one in FIG. 7 described above, is as shown in FIG. 19.

FIG. 19 shows a correlation map acquired based on FIG. 18.

[2, 2, 2] is set as a mask pattern (basic pattern) to the correlation map of FIG. 19 or the presence of a basic pattern is judged according to the ratio of high correlation area to the area subject to judgment or the position of [the value] indicating high correlation area in the basic pattern so that CODE128 may respond to those, a barcode map similar to the above-described map of FIG. 8, and the presence of CODE128 may be detected.

Afterward, according to the barcode map, the position of the symbol CODE128 on the image space is determined, and then the decoding operation follows.

Subsequently, a symbol detector prepared for PDE417 is used next for the same input image.

As parameters for the detector, the dimensions of a lattice block are set to be suitable for the shape of PDF417. In this case, the same lattice block as for CODE128 is used. Accordingly, a correlation map is created as shown in FIG. 19.

While a value ‘2’ appears in the entire symbol area of a 1D barcode symbol, a value ‘2’ appears only in the elements corresponding to the right and left ends and a value ‘0’ appears in the elements in the middle portion of the barcode PDF417.

Then, for the barcode PDF417, the mask pattern search is carried out assuming that a 2D barcode exists. In other words, a pair of similar patterns at the left end and right end are searched for in the correlation map. After a pair of patterns are once detected, the rectangular area interposed between the pair of patterns is mapped on the image space coordinate system so as to determine the barcode position according to the characteristics of the 2D barcode, and then a decoding operation follows.

In this embodiment, the present invention is applied to a combination of a 1D imaging element and a linear transfer mechanism. However, the present invention is not limited to this, but may also be applied to a combination of an area sensor such as a two-dimensional CCD, a CMOS imager, etc. and an objective medium supporting mechanism as well as another combination of a one-dimensional imaging element and a manual medium driving mechanism.

In the above modification example, a PDF417 format is used for the barcode symbol label. However, the present invention is not limited to this format, but a stack-type barcode such as Code 49 or the like may be used for the barcode symbol label.

The method described above in detail can be created as a program according to the above-described steps and executed by a computer such as a CPU.

Such a program can be configured to be accessed and executed by a computer having a recording medium such as a semiconductor memory, a magnetic disk, an optical disk or a floppy disk (trade mark) installed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A symbol information reader for use with a medium on which symbol information is recorded, the symbol information reader comprising:
an imaging device configured to image the medium;
an image memory configured to store image data of said medium acquired by said imaging device; and
a position detection processor configured to retrieve said image data and detect the position of said symbol information recorded on said medium;
wherein said position detection processor comprises:
a temporary area judging unit configured to calculate brightness changes along the scanning direction of scanning lines for said symbol information in a predetermined area of said image data and identify a temporary area that has a possibility of corresponding to said symbol information,
a correlation map creating unit configured to calculate a correlation of said temporary area with the areas neighboring in a direction perpendicular to the scanning direction of said scanning lines and create a map that indicates the area of high correlation value,
a labeling unit configured to search said correlation map for the presence of a basic barcode and label an area judged as having said basic barcode, and
a position determining unit configured to detect the position of said symbol information recorded on said medium, based on said labeled area, and
when searching said correlation map acquired at said correlation map creating unit for a predetermined basic pattern and labeling, said labeling unit judges whether said basic pattern is present or not according to the ratio of high correlation area to the area subject to judgment or the position of high correlation area in said basic pattern.

2. The symbol information reader as set forth in claim 1, wherein said labeling unit is configured to regard that said searched pattern is the basic pattern if the ratio of the number of element values indicating high correlation to the number of elements composing said basic pattern is equal to or larger than a predetermined ratio.

3. The symbol information reader according to claim 1, wherein said labeling unit is configured to regard that said searched pattern is the basic barcode even if the sum of element values of all elements in said basic pattern is smaller than the sum of element values when all are of high correlation, as long as it is equal to or larger than a predetermined value.

4. The symbol information reader according to claim 1, wherein said labeling unit is configured to regard that said searched pattern is the basic barcode if an element value that indicates high correlation appears in a predetermined form at predetermined positions in the basic pattern consisting of multiple elements.

5. The symbol information reader according to claim 1, wherein said labeling unit, in basic pattern search, is configured to:
form basic pattern areas by shifting elements one by one on said correlation map,
judge each of said basic pattern areas to find whether a basic pattern is present or not, according to the ratio of high correlation area to an area subject to judgment or the position of high correlation area in the basic pattern,
wherein when it is judged as not to be said basic barcode, said basic pattern is regarded as uncertain, and
when the following basic pattern after the shift by one element is regarded as a basic barcode, said uncertain basic pattern is regarded as a basic barcode.

6. A method for reading symbol information comprising:
imaging a medium on which symbol information is recorded;
storing image data of said medium in a storage unit;
retrieving said image data and detecting the position of said symbol information recorded on said medium;
wherein said detecting the position of said symbol information comprises:
calculating brightness changes d along the scanning direction of scanning lines of symbol information in a predetermined area of said image data and identifying temporary area having a possibility of corresponding to said symbol information,
calculating correlations of said temporary area with areas neighboring in a direction perpendicular to said scanning direction of said scanning lines and creating a map indicating areas of high correlation,
searching the presence of a basic barcode in said correlation map and labeling the area judged as having said basic, and
detecting the position of said symbol information recorded on said medium, based on said labeled area, and
in said labeling step,
when a predetermined basic pattern is searched in said correlation map and an area judged as having said basic barcode is labeled, it is judged whether a basic pattern is present or not, according to the ratio of high correlation area to an area subject to judgment or the position of high correlation area in said basic pattern.

7. The method for reading symbol information according to claim 6, wherein said basic pattern is regarded as a basic barcode if the ratio of the number of the element values that indicate high correlation to the number of the elements in said basic pattern is equal to or larger than a predetermined value.

8. The method for reading symbol information according to claim 6, wherein said basic pattern is regarded as the basic barcode even if the sum of the element values of all the elements in said basic pattern is smaller than the sum of the element values obtained when all are of high correlation as long as it is equal to or larger than a predetermined value.

9. The method for reading symbol information according to claim 6, wherein said pattern is regarded as the basic barcode if an element value of high correlation is set in a predetermined form at predetermined positions in said basic pattern composed of multiple elements.

10. The method for reading symbol information according to claim 6, wherein in the basic pattern search processing,
basic pattern areas are formed by shifting elements one by one in said correlation map, every basic pattern area is judged whether a basic pattern is present or not, according to the ratio of high correlation area to an area subject to judgment or the position of high correlation area in the basic pattern; when it is not judged that the basic pattern is said basic barcode, said basic pattern is regarded uncertain; when it is judged that the following basic pattern after the shift by one element is the basic barcode, said basic pattern regarded uncertain is now judged as the basic barcode.

11. A computer readable medium including computer-readable instructions that, when executed by a computer, cause the computer to perform:
executing a symbol information reading operation that includes retrieval of tan image data of a medium, on which symbol information is recorded;
executing position detection processing of said symbol information recorded on said medium;
wherein said position detecting processing comprises:
a temporary area judging processing for calculating brightness changes along the scanning direction of scanning lines for said symbol information in a predetermined area of said image data and identifying a temporary area having a possibility of corresponding to said symbol information;
a correlation map creating processing for acquiring correlations of said temporary area with neighboring areas adjacent in a direction perpendicular to said scanning direction of said scanning lines and creating a map that shows areas of high correlation;
a labeling processing for searching said correlation map for the presence of a basic barcode and labeling the area judged as having said basic barcode; and
a position determining processing for detecting the position of said symbol information recorded on said medium, based on said labeled area;
and in said labeling processing,
when a predetermined basic pattern is searched in said correlation map acquired in said correlation map creating processing and labeled, it is judged whether a basic pattern is present or not according to the ratio of high correlation area to an area subject to judgment or the position of high correlation area in said basic pattern.
